(19) United States
(12) Patent Application Publication
(10) Pub. No.: US 2022/0315775 A1
(43) Pub. Date: Oct. 6, 2022

(54) COATING COMPOSITIONS FOR HYDROPHOBIC FILMS AND ARTICLES HAVING HYDROPHOBIC SURFACES

(71) Applicant: W. R. GRACE & CO.-CONN., Columbia, MD (US)

(72) Inventor: Feng GU, Ellicott City, MD (US)

(73) Assignee: W. R. GRACE & CO.-CONN., Columbia, MD (US)

(21) Appl. No.: 17/608,716

(22) PCT Filed: Apr. 15, 2020
(86) PCT No.: PCT/US2020/028332

§ 371 Date: Nov. 3, 2021

Related U.S. Application Data
(60) Provisional application No. 62/844,313, filed on May 7, 2019.

(51) Int. Cl. C09D 7/62; C09D 7/40; C09D 183/04

(52) U.S. Cl. CPC C09D 7/62; C09D 7/69; C09D 183/04; C08K 3/36

(57) ABSTRACT

This invention relates to a coating composition. The coating composition may include hydrophobized silica particles, a film-forming binder, and a solvent. The hydrophobized silica particles comprise porous silica particles having a pore diameter of about 80 or more which have been treated to form a hydrophobic coating on a surface of the porous silica particles.

### FIELD OF THE INVENTION

The present invention relates to the making and the use of the hydrophobic particles to produce a surface with difficult-to-wet property. In particular, the present invention relates to hydrophobilized silica particles, coating compositions comprising these hydrophobilized silica particles, coated surfaces that are difficult-to-wet using these coating compositions, and processes for producing such difficult-to-wet surfaces.

### BACKGROUND

Usual surfaces are generally wetted by liquids such as water. The degree of wetting is the result of interplay between the forces of cohesion in the liquid and the forces of adhesion between liquid and surface.

In many cases, the wetting of a surface by a liquid is unwanted. For example, the wetting of surfaces with water results in the retention of water droplets on the surface and their evaporation, with the solids suspended or dissolved in the water remaining as unsightly residues on the surface. This problem exists in particular with surfaces exposed to rainwater. The wetting of a surface with water is frequently also a trigger for its corrosion or for infestation with microorganisms and with growths such as algae, lichen, mosses, bivalves, etc.

In the context of packaging and storage vessels for liquids, low wettability of the interior surfaces is desired, so that none or only small amounts of liquid remain when the packaging or storage vessel is emptied. In the field of apparatus and plant construction, as well, low wettability of components which come into contact with liquids is desired. If, indeed, the wettability of the components is high, there is a risk of increased formation of coverings and deposits. Furthermore, increased wettability generally has the consequence of increased flow resistance of liquids in pipelines.

It is known that the wettability of a surface by hydrophilic liquids may be reduced by a hydrophobic coating of the surface. Examples for suitable coating materials in this context include hydrophobic waxes, polyalkylsiloxanes and perfluorinated polymers, especially the extremely hydrophobic polytetrafluoroethylene (Teflon). The coating reduces the forces of adhesion between liquid and wetted surface.

Furthermore, it has proven favorable to have structured hydrophobic surfaces. Surface structures of this kind generally have regular or irregular elevations or depressions in nanometer or micrometer scale. These structures, often referred as surface roughness, invite the participation of air to repel liquid such as water. As described by Cassie-Baxter Equation below:

cos θ_{CB}=f*cos θ−(1−f)

In the equation, θ_{CB} is the water droplet contact angle of the rough surface made with certain hydrophobic material in the coated layer. θ is water droplet contact angle of the smooth surface material itself, and f is the fraction of water contacted surface area to the total surface area, and thus (1−f) is the fraction of the non-contacted area (air pockets) to the total surface area. In order to achieve θ_{CB} close to 180° (i.e., when cos θ_{CB} close to −1, cos θ is close to 0), it is desirable to have very small f values.

Superhydrophobic surfaces are surfaces on which contact angles of a water droplet exceed 150°, and it is generally recognized that superhydrophobic surfaces require both hydrophobic material and surface roughness. In nature, mono-microstructure model for lotus leaves with superhydrophobicity and self-cleaning properties was reported in 1997 (Barthlott, W.; Neinhuis, C. “Purity of the sacred lotus, or escape from contamination in biological surfaces,” Planta 1997, 202 (1), 1-8) and it was described as caused by micro scaled papillae and hydrophobic epicuticular wax.

US 2017/0121530 discloses a paint that imparts a superhydrophobic surface on an object. The paint is a suspension of hydrophobic particles in a polymeric binder and a plasticizer in a solvent or mixed solvent. The particles are metal oxides such as silica particles that are surface functionalized with a fluorinated alkyl silane or an alkyl silane. The silica particles may have specific surface areas in a range of 35-65 m²/g and diameters in a range of 50 to 110 nm.

U.S. Pat. No. 6,683,126 discloses a coating composition for producing difficult-to-wet surfaces. The coating composition may include at least one finely divided powder which has a hydrophobic surface and a porous structure characterized by a BET surface area of at least 1 m²/g and at least one film-forming binder characterized by a surface tension <50 mN/m. The weight ratio of powder to binder is at least 1:4.

US 2009/0018249 discloses a hydrophobic self-cleaning coating composition. The coating composition may include a hydrophobic fumed silica ranging in size from 1000 to 4,000 nanometers in an effective amount of up to 5.0 percent by weight based on the total weight of the composition and a solvent or solvent mixture. The coating composition results in a coated surface providing a contact angle of at least 165 degrees as compared to water having a contact angle of from 10 to 15 degrees on a noncoated surface.

### BRIEF SUMMARY

We hereby disclose a coating composition comprising porous silica particles of certain particle sizes and pore diameters which, additionally, are hydrophobized with hydrophobic organic molecules or polymers, and at least one hydrophobic polymeric binder.

In some embodiments, the coating composition includes hydrophobized porous silica particles; a film-forming hydrophobic binder; and a solvent. The hydrophobized porous silica particles comprise silica particles having a pore diameter of about 100 Å or more and modified with hydrophobic organic molecules or polymers on a surface of the porous silica particles.

Another example of the present invention is an article. The article may include at least one difficult-to-wet surface which is composed essentially of the coating composition according to one embodiment of the present invention.

### DETAILED DESCRIPTION

The present disclosure will be described in further detail with reference to the accompanying embodiments in order to provide a better understanding by those skilled in the art of the technical solutions of the present disclosure.

The following terms, used in the present description and the appended claims, have the following definition.

A numerical range modified by “about” herein means that the upper and lower limits of the numerical range can vary by 10% thereof. A numerical value modified by “about” herein means that the numerical value can vary by 10% thereof.

The term “hydrophobized” is used herein to indicate silica particles are modified with hydrophobic molecules or polymers that include long chain hydrocarbon, perfluorocarbon or siloxane groups.

The term “hydrophobic” refers to a surface, a film, or a coating that is difficult to wet with water. A surface would be considered hydrophobic if it demonstrated a static water contact angle of at least 90, very hydrophobic if it demonstrated a static water contact angle of at least 110°. The term “superhydrophobic” refers to a surface, a film, or a coating that is extremely difficult to wet with water. A superhydrophobic surface or coating will usually have static water contact angles in excess of 130°, and often in excess of 140°.

The term “porous” refers that particles have a nitrogen pore volume (BJH method, see Barrett et al, J. Am. Chem. Soc., 73, 373-380, 1951) of at least 0.1 cc/g.

The term “pore diameter” (PD) is defined as PD (Å)=40,000*PV/SA based on a cylindrical model, wherein PV represents nitrogen pore volume in cc/g of the particles, and SA represents a BET surface area (see Brunauer et al, J. Am. Chem. Soc., 60, 309-319, 1938) in m²/g of the particles.

Some embodiments of the present invention accordingly provide a composition, especially in the form of a coating composition, for producing difficult-to-wet surfaces, comprising i) hydrophobized porous silica particles, ii) a hydrophobic film-forming binder, and iii) a solvent. In one embodiment, the hydrophobized silica particles comprise porous silica particles which have been treated to form a hydrophobic coating on a surface of the porous silica particles. The porous silica particles, prior to hydrophobilization, have pore diameter of about 80 Å or more, preferably about 90 Å or more, more preferably about 100 Å or more. In one embodiment, the pore diameter ranges from about 80 Å to about 1000 Å, preferably from about 100 Å to about 500 Å. A weight ratio of hydrophobized silica particles to the film-forming binder is at least 1:2.5, preferably at least 1:2. In one embodiment, the solvent includes one or more organic solvents or water.

The porous silica particles used to prepare the compositions of the present invention may have various particle sizes. The phrase “particle size” refers to median particle size (D50, which is a volume distribution with which 50 volume percent of the particles are smaller than this number and 50 volume percent of the particles are larger than this value in size) measured by dynamic light scattering and when the particles are slurried in water or an organic solvent such as acetone or ethanol. In general, the porous silica particles have a median particle size in a range of from about 0.5 μm to about 50 μm, with particular preference to a range of from about 1 μm to about 15 μm.

The porous silica particles used to prepare the compositions according to some embodiments of the present invention are characterized by an initial specific surface area prior to hydrophobilization. The specific surface area is the BET surface area determined in accordance with DIN 66131. The porous silica particles preferably have a BET surface area in the region of at least 5 m²/g, in particular at least 10 m²/g, and with particular preference at least 20 m²/g. In particular, the BET surface area of the porous silica particles is in the range from 5 to 1000 m²/g, with particular preference in the range from 10 to 800 m²/g, and with very particular preference in the range from 20 to 750 m²/g.

In one embodiment, the porous silica particles are modified with hydrophobic molecules or polymers on the surface of the particles to form the hydrophobized silica particles. The hydrophobic molecules or polymers may be physically coated or chemically modified to the surface of silica particles. Preferably, the hydrophobic molecules or polymers are covalently bonded onto the surfaces of the particles. The hydrophobic coating on the surface of the silica particles may be formed by contacting the silica particles with a hydrophobic silane or siloxane that contains at least one reactive functional group and that undergoes a chemical reaction with surface silanol groups of the silica particles.

The hydrophobic molecules or polymers may comprise nonpolar organic molecules. Examples of the hydrophobic molecules or polymers include but not limited to waxes, silanes and siloxane polymers. In one embodiment, the hydrophobic molecules include silanes having a large number of alkyl groups (—CH₂—) or (per)fluoroalkyl groups (—CF₂—). The alkyl or per(fluoroalkyl) groups may include at least 4 carbon atoms. In one embodiment, the hydrophobic polymers are siloxane polymers including polydialkylsiloxane groups (—OSi(R₂)—, such as polydimethylsiloxane groups (—OSi(Me)₂-), which may be linked with the silica particles, for example, by covalent bonds.

The hydrophobized silica particles according to some embodiments of the present invention are generally obtained by treating the porous silica particles with alkylsilane, perfluoroalkylsilanes, and/or siloxane polymers that can undergo chemical reaction with the surface silanol groups of the oxide support particles. The alkylsilanes or (perfluoro)alkylsilanes may have weight averaged molecular weights of at least 200 dalton. The polydialkylsiloxanes may have weight averaged molecular weights of at least 800 dalton. Examples of the hydrophobic silane or siloxane include octadecyl trimethoxysilane, octadecyl trichlorosilane, perfluorooctyltrimethoxysilane, polydimethoxysilane, or silanol terminated polydimethylsiloxane.

The hydrophobized silica particles may be prepared by a solution modification process, a dry modification process, or a milling and modification process. In one embodiment, hydrophobized silica particles are prepared by a solution modification process involving the mixing of the particles with a solution of hydrophobic silanes and/or siloxanes in an organic solvent or a mixture of organic solvents. The mixture is thereafter blended with stirring for a time and at a temperature sufficient to allow reaction between surface silanol groups on the silica particles and functional groups on the hydrophobic silanes and siloxanes. Preferably, the mixture is blended for about 5 to about 20 hours, with most preference of at least 8 hours, and a temperature ranging from ambient to about 120° C.

In another embodiment, the hydrophobized silica particles may be prepared by a dry modification process, which involves a continuous mixing of the particles with liquid silanes and siloxanes without the presence of a solvent. The mixing is preferably performed for a time and at a temperature sufficient to accomplish the reaction between surface silanol groups on the silica particles and the functional groups on the hydrophobic silanes and siloxanes, e.g. for about 5 to about 20 hours, at a temperature ranging from ambient to about 120° C. Preferably, the dry bonded mixture is heated at a high temperature, for example, 120° C., for about 5 to about 15 hours.

In yet another embodiment, the hydrophobized silica particles are prepared by a continuous mixing and milling process, preferably, using a spiral jet mill process. The silica particles are milled and modified with the hydrophobic silanes or siloxane polymers to obtain the hydrophobized silica particles having the desired particles size.

In general, the hydrophobized silica particles have a median particle size from about 0.5 μm to about 50 μm. In a preferred embodiment, the hydrophobized silica particles may have a median particle size ranging from about 1 μm to about 15 μm.

The film-forming binders useful in the present invention may vary depending on the desired end use. The film-forming binders are typically organic polymers or other hydrophobic organic substances such as waxes which may form a solid film on a surface. The film-forming binders serve, for example, to fix the powder particles on the surface of the substrate to be coated or to fix the powder surfaces to one another when the compositions are used as powders or to produce a shaped article. The film formed by the binder may be sufficiently hydrophobic (water contact angle of at least 80°). However, for coated film with good durability, the types of polymers or other organic substrates are important, in some embodiments, the polymers or organic substances are capable of crosslinking in the presence of some crosslinking agents, and after the crosslinking, the coated films can become very durable.

The hydrophobicity of the binder is characterized using its surface tension. This may be determined, for example, by measuring the static contact angle of water on a smooth surface coated with the binder. Hydrophobic binders feature static contact angles for water of at least 80°.

In one embodiment, the film-forming binder is characterized by a surface tension <50 mN/m and which is selected from the group consisting of C₂-C₆ polyolefins, homopolymers of ethylenically unsaturated monomers containing C₈-C₆ alkyl groups, and copolymers of ethylenically unsaturated monomers containing C4-C36 alkyl groups, C1 to C36 alkyl vinyl ethers, vinyl esters of C₁ to C₃₆ carboxylic acids, and ethylenically unsaturated comonomers copolymerizable therewith, natural waxes, and synthetic waxes.

The binders may comprise thermoplastic polymers which are soluble in organic solvents. Alternatively, the binders, in small particle size format (with a particle size of between 50 nm to 1 μm range), can also be dispersed in water or other solvents with or without ionic or non-ionic surfactants. The binders used may also comprise organic prepolymers which are crosslinked by a thermal, oxidative or photochemical curing process and so form a solid coating with the particles.

Furthermore, binders may be fatty acids having more than 8 carbon atoms, especially ethylenically unsaturated fatty acids, and their esters with polyfunctional alcohols such as glycerol, ethylene glycol, propanediol, sorbitol, glucose, sucrose or trimethylolpropane, the fatty acids and their esters curing oxidatively and so being included in the class of the prepolymers. Also suitable as binders are natural waxes such as paraffin wax, beeswax, carnauba wax, wool wax, candelilla wax, and also synthetic waxes such as montanic acid waxes, montanic ester waxes, amide waxes, e.g., distearoylethylenediamine, Fischer-Tropsch waxes, and also wax like polymers of ethylene and of propylene (polyethylene wax, polypropylene wax). As discussed above, these waxes can be wax particles dispersed in water with certain surfactants.

The film-forming binder may be formed from hydrophobic monomers, which are selected from C2-C24 olefins, C5-C8 cycloolefins, fluoroolefins, fluorochloroolefins, vinyl aromatics, diolefins such as butadiene, isoprene and chlorobutadiene, and different monoethylenically unsaturated monomers containing at least one C2-C36 alkyl group, etc.

Examples of preferred hydrophobic monomers are C2-C24 olefins, such as ethylene, propylene, n-butene, isobutene, n-hexene, n-octene, isooctene, n-decene, isotridecene, C5-C8 cycloolefins such as cyclopentene, cyclopentadiene, cyclooctene, vinyl aromatic monomers, such as styrene and α-methylstyrene, and also fluoroolefins and fluorochloroolefins such as vinylidene fluoride, chlororifluoroethylene, tetrafluoroethylene, vinyl esters of linear or branched alkane carboxylic acids having 2 to 36 carbon atoms, e.g., vinyl acetate, vinyl propionate, vinyl n-butyrate, vinyl isobutyrate, vinyl hexanoate, vinyl octanoate, vinyl laurate and vinyl stearate, and also esters of acrylic acid and of methacrylic acid with linear or branched C2-C36 alkanols, e.g., ethyl (meth)acrylate, n-butyl (meth)acrylate, tert-butyl (meth)acrylate, n-hexyl (meth)acrylate, 2-ethylhexyl (meth)acrylate, 2-propylheptyl (meth)acrylate, lauryl (meth)acrylate and stearyl (meth)acrylate and also vinyl ethers and allyl ethers of C2-C36 alkanols, such as n-butyl vinyl ether and octadecyl vinyl ether, fluorinated monomers.

The film-forming binders may include polyethylene, polypropylene, polyisobutene, polychlorotrifluoroethylene, polytetrafluoroethylene, polyvinyl acetate, polyethyl methacrylate, poly-n-butyl methacrylate, polyisobutyl methacrylate, poly-tert-butyl methacrylate, polyhexyl methacrylate, poly(2-ethylhexyl methacrylate), polyethyl acrylate, poly-n-butyl acrylate, polyisobutyl acrylate, poly-tert-butyl acrylate, poly(2-ethylhexyl acrylate), and copolymers of maleic acid with at least one hydrophobic monomer selected from C3-C6 olefins, C1-C36 alkyl vinyl ethers, and the vinyl esters of aliphatic C1-C36 carboxylic acids.

Further suitable film-forming binders are poly-C1-C4-alkylene oxides, such as polyoxymethylene, polypropylene oxide and polybutylene oxide, polytetrahydrofuran and also polycaprolactone, polycarbonates, polyvinylbutyral, polyvinylformal, and also linear or branched polydialkylsiloxanes such as polydimethylsiloxane (silicones). The silicones can be crosslinked with tetraethyl orthosilicate with a tin complex compound as catalyst.

Further suitable film-forming binders include partly aromatic polyesters made from aliphatic or aromatic dicarboxylic acids and aliphatic and/or aromatic diols, e.g.: polyesters synthesized from aliphatic dialcohols having 2 to 18 carbon atoms, e.g., propanediol, butanediol, hexanediol, and dicarboxylic acids having 3 to 18 carbon atoms, such as adipic acid and decanedicarboxylic acid; polyesters synthesized from bisphenol A and the above mentioned dicarboxylic acids having 3 to 18 carbon atoms; and polyesters synthesized from terephthalic acid, aliphatic dialcohols having 2 to 18 carbon atoms, and dicarboxylic acids having from 3 to 18 carbon atoms.

The polyesters may optionally be terminated by long-chain monoalcohols having 4 to 24 carbon atoms, such as 2-ethyl hexanol or octadecanol. Furthermore, the polyesters may be terminated by long-chain monocarboxylic acids having 4 to 24 carbon atoms, such as stearic acid.

The weight-average molecular weight of the film-forming binder polymers may vary over a wide range and is generally in the range from 1000 to 10 million g/mol and preferably in the range from 2500 to 6 million, in particular 2500 to 5 million, g/mol (determined by viscometry). Where the binder polymer is a polyolefin, and especially polyisobutene, its weight-average molecular weight is preferably in the range from 30,000 to 6 million g/mol, or in the range from 500,000 to 5 million g/mol. In the case of polyoctadecyl vinyl ether, the molecular weight is preferably in the range from 2000 to 10,000 g/mol and in particular in the range from 2500 to 5000 g/mol.

In some embodiments, the film-forming binders are photochemically and/or thermally crosslinkable binders, which are polymers and oligomers having ethylenically unsaturated double bonds, as used to prepare radiation-curable coating materials. These binders include, for example, flowable formulations of polyether acrylates, polyester arylates, polyurethane acrylates, polyesters with condensed maleic anhydride units, epoxy resins, e.g., aromatic epoxy resins, the oligomers and/or polymers being present, if desired, in solution in organic solvents and/or reactive diluents in order to improve their flowability. Reactive diluents include low molecular mass, ethylenically unsaturated liquids which on crosslinking form the coating together with the ethylenically unsaturated polymers.

Bisphenol based epoxy resin systems can also be used as the film-forming binder. These resins can be crosslinked and cured with amines and diamines, and particularly, the amines and diamines can consist of long hydrocarbon chains (>6) to make the cured epoxy surface hydrophobic.

Radiation-curable binders, and formulations comprising these binders, are well known to the skilled worker, e.g., from P. K. T. Oldring (Ed.) “Chemistry and Technology of UV & EB Formulation for Coatings, Inks & Paints”, Vol. 2, 1991, Sita Technology London, and available commercially, for example, under the commercial brands Laromer® P084F, Laromer®LR8819, Laromer®PE55F, Laromer®LR8861, BASF Aktiengesellschaft, Ludwigshafen.

Binders in accordance with some embodiments of the present invention are C2-C6 polyolefins, especially polyisobutene, atactic, isotactic, and syndiotactic polypropylene, polyethylene, and also homopolymers and copolymers of ethylenically unsaturated monomers containing C4-C36 alkyl groups, especially containing C8-C22 alkyl groups, and, if desired, ethylenically unsaturated comonomers copolymerizable therewith, and also C3-C4 polyalkylene oxides. Of these, particular preference is given to homopolymers and copolymers of C8-C36 alkyl vinyl ethers, e.g., polyoctadecyl vinyl ether.

In one embodiment, the film-forming binder comprises a fluorine-containing polymer and the solvent comprises one or more organic solvents. The fluorine-containing polymer may be polytetrafluoroethylene, polyhexafluoropropene, tetrafluoroethylene hexafluoropropene copolymer, alkoxy fluoroethylene copolymer, ethylene-tetrafluoroethylene copolymer, or a combination thereof.

In one embodiment, the coating composition further includes a cross-linker for crosslinking the film-forming binder. In one embodiment, the coating composition further includes an initiator and the cross-linker comprises two or more carbon-carbon double bonds. In one embodiment, the film-forming binder further comprises a gelation agent.

In one embodiment, the film-forming binder comprises an aqueous wax emulsion or an aqueous emulsion of the hydrophobic polymer and the solvent comprises water. In one embodiment, the coating composition is prepared by dispersing the hydrophobized silica particles in water in a presence of a surfactant to form a suspension of the hydrophobized silica particles, and then mixing the wax emulsion or the emulsion of the hydrophobic polymer with the suspension of the hydrophobized silica particles. In one embodiment, the film-forming binder is present in an amount of about 1% to about 30% by weight of the coating composition.

In order to achieve the low wettability effect desired in accordance with some embodiment of the present invention, the weight ratio of hydrophobic silica particles i) to binder ii) in the compositions may be at least 30%, preferably at least 35%, and with particular preference at least 40, with very particular preference at least 50%. This weight ratio will preferably not exceed a value of 75%, in particular 80%. With very particular preference, the weight ratio of i) to ii) is in the range from 40% to 60%.

The coating compositions according to some embodiments of the present invention may be used in a dry form, i.e., as a powder formulation comprising both the finely divided hydrophobic particles i) and the hydrophobic polymeric binder ii).

In one embodiment, the coating composition is employed in a form which is fluid at the processing temperature. The coating compositions may of course be processed both at room temperature and at temperatures above or below room temperature, for example, at temperatures in the range from 0° C. to 150° C., depending on the nature of the formulation.

In the fluid form, the coating compositions of some embodiments of the present invention generally comprise not only the powder i) and the binder (ii) but also, if desired, a diluent or solvent, preference being given to those solvents which dissolve the polymeric binder but not the finely divided powder i). Alternatively, the binders can also be homogeneously dispersed in the solvents or water with help of a surfactant or surfactants. This improves the formation of the coating.

Suitable solvents are volatile organic solvents or water which evaporate following the application of the coating, with or without heating, thereby permitting the formation of a uniform film of the binder polymer. Examples of suitable solvents are ketones, such as acetone and ethyl methyl ketone, volatile esters of acetic acid, such as ethyl acetate and n-butyl acetate, cyclic ethers, such as tetrahydrofuran, and also aliphatic and aromatic hydrocarbons, such as turpentine oil, petroleum, petroleum spirit, toluene, and xylene. Polar solvents can also be used. For example, hydrophobic thermoplastic polyurethanes can only be dissolved in dimethylformamide (DMF), and in this case, DMF can be used in the formulation.

In the liquid formulations, the solids content (total amount of particles i) and polymer binder ii), based on the overall weight of the formulation) is in the range from 0.5 to 80% by weight. In the coating compositions, the solids content may be frequently in the range from 10 to 50% by weight. In the case of sprayable coating materials, it may also be below this level, e.g., in the range from 0.5 to 10% by weight.

Another example of the present invention is a hydrophobic film formed from the coating composition according to one embodiment of the present invention, wherein the hydrophobic film exhibits a static contact angle for deionized water at room temperature equal to or greater than about 140° and a rolling rating of at least 1 in a scale of 0-3. In one embodiment, the hydrophobic film is produced by a method selected from the group consisting of spin coating, dip coating, spray coating, roller coating, drawdown, brush coating, and a mixture thereof.

To produce the difficult-to-wet surface, the coating compositions according to some embodiments of the present invention are applied conventionally to the substrates that are to be coated. In principle, all conventional surfaces may be coated with the coating compositions of the present invention. Examples of conventional surfaces are the surfaces of wood, metal, glass and plastic. The coating compositions of the present invention may of course also be used to coat rough and/or porous surfaces, such as concrete, plaster, paper, woven fabric, examples including textile woven fabric for clothing, umbrellas, tents, and marquees, and for comparable applications, and also leather and hair as well.

The application of the coating to the surface that is to be coated (also referred to as the substrate herein below) is made, depending on the embodiment of the coating composition and on the nature of the substrate, in accordance with the application techniques customary in coatings technology. In the case of flowable coating compositions containing solvent, application is made generally by brushing, spraying, e.g., by means of airbrush, dipping or rolling, with subsequent drying of the coating, during which the solvent evaporates.

If the binder ii) used is a thermally, oxidatively or photochemically crosslinkable prepolymer, then the coating compositions are in many cases flowable even without adding solvents and may be applied by the abovementioned technique, possibly following dilution with a reactive diluent. In this case, the actual coating is formed by thermal, oxidative or photochemical curing (crosslinking) of the prepolymers. One particular example is epoxy prepolymer and the curing of the epoxy polymer.

In order to achieve the desired effect, the coating composition will be applied preferably in an amount of at least 0.01 g/m², in particular at least 0.1 g/m², and especially at least 0.5 g/m² and preferably not more than 1000 g/m², based on the solid constituents of the coating composition, to the surface that is to be coated. Solid constituents in this context are essentially the components i) and ii). This corresponds to a real weight of the coating, following the evaporation of volatile constituents, of at least 0.01 g/m², in particular at least 0.1 g/m², and especially at least 0.5 g/m². In many cases, the coatings are applied in amounts of up to 100 g/m² to the surface that is to be coated (based on solid constituents), although in other forms of application, larger amounts of coating composition will be applied, for example, in the case of coatings in the form of masonry paints, or in the context of the coating of concrete roofing slabs.

Another embodiment according to some embodiments of the present invention relates to the use of the compositions for producing shaped articles having difficult-to-wet surfaces. In one embodiment, the article includes at least one difficult-to-wet surface which is composed essentially of a coating composition according to one embodiment of the present invention. The difficult-to-wet surface may exhibit a static contact angle for deionized water at room temperature equal to or greater than about 140° and a rolling rating of at least 1 in a scale of 0-3. The article may be made of at least a material selected from the group consisting of glass, metal, plastics, wood, concrete, fabrics, cellulosic materials, and paper.

The same advantageous properties as the surfaces coated in accordance with the present invention are also possessed by the shaped articles produced from the compositions of the present invention. Furthermore, the shaped articles surprisingly do not lose these properties even when their surface is destroyed, by roughening or scratching, for example. This property makes it possible to regenerate the advantageous surface properties if the surfaces age.

Moreover, the flow resistance of liquids, especially water and aqueous solutions, is reduced when they flow through pipes, capillaries or nozzles which have been coated with the coatings according to some embodiments of the present invention. On the basis of their properties, the compositions of the present invention can be put to a great diversity of uses.

Materials susceptible to corrosion, such as concrete, including steel-reinforced concrete, wood or metal may be effectively protected against corrosion by coating with the coating compositions of the present invention. The compositions according to some embodiments of the present invention are suitable, moreover, for the surface finishing of paper, card, or polymer films.

Fabrics, especially textile fabrics, which have been provided with the compositions according to some embodiments of the present invention are notable for a high level of imperviousness to water and a low level of water absorption, and repel dirt. By treatment with the compositions according to some embodiments of the present invention, the fabric becomes downright water-repellent. Particles of dirt can easily be rinsed off with water without any significant absorption of water. The compositions according to some embodiments of the present invention are suitable, accordingly, as a water- and dirt-repellent finish for fabric which can be used, for example, to produce clothing, tents, marquees, tarpaulins, umbrellas, to line compartments, e.g., motor vehicle interiors, to line seating areas, in the automotive sector, for example.

Leather which has been treated with the compositions according to some embodiments of the present invention is suitable for producing leather clothing and shoes having water- and dirt-repellent properties. In the field of cosmetology, the compositions according to some embodiments of the present invention may be used as hair treatment compositions, e.g., in the form of hairsprays, provided they comprise a cosmetically compatible binder i), e.g., the polymers commonly employed for this purpose. Components and shaped articles can be used in a similar fashion.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Hereinafter, the present invention will be described in more detail with reference to Examples. However, the scope of the present invention is not limited to the following Examples.

### EXAMPLES

### Materials

The particle sizes were determined by a light scattering method using a Malvern Mastersizer 2000 or 3000 available from Malvern Instruments Ltd. per ASTM B822-10. Median particle size D50 was reported.

The “BET surface area” of the particles was measured by the Brunauer Emmet Teller nitrogen adsorption method (Brunauer et al, J. Am. Chem. Soc., 1938, 60(2), 309-319), and nitrogen pore volume refers to the average pore volume of a plurality of particles determined using the Barrett-Joyner-Halenda (BJH) nitrogen porosity as described in DIN 66134.

The carbon content of the particles was measured using a LECO Carbon Analyzer SC-632 available from LECO Corp.

Table 1 lists properties of the silica particles used in examples such as median particle size (PS) D50, BET surface area (BET), pore volume (PV), Pore diameter (PD) (as calculated as 40,000×PV/BET SA (in Å). Two types of silicas were included in the examples, and these are silica gel (Gel) and precipitated silica (ppt).

TABLE 1

| | | Particle | | | | |
|---|---|---|---|---|---|---|
| Particle | Nature of | Size | BET SA | PV | PD | |
| ID | Particles | (μm) | (m²/g) | (cc/g) | (Å) | Comments |
| P-1 | Gel | 5 | 700 | 0.40 | 23 | |
| P-2 | Gel | 5 | 218 | 0.17 | 31 | 900° C., |
| | | | | | | pyrolyzed P-1 |
| P-3 | Gel | 5.0 | 500 | 1.0 | 80 | |
| P-4 | Gel | 5.0 | 87 | 0.15 | 67 | 900° C., |
| | | | | | | pyrolyzed P-3 |
| P-5 | ppt | 6.0 | 749 | 2.0 | 107 | |
| P-6 | ppt | 6.0 | 301 | 0.83 | 111 | 900° C., |
| | | | | | | pyrolyzed P-5 |
| P-7 | Gel | 9.0 | 350 | 1.2 | 137 | |
| P-8 | Gel | 9.0 | 221 | 0.9 | 164 | 900° C., |
| | | | | | | pyrolyzed P-7 |
| P-9 | Gel | 8.0 | 343 | 1.6 | 188 | |
| P-10 | Gel | 8.0 | 228 | 1.04 | 183 | 900° C., |
| | | | | | | pyrolyzed P-9 |
| P-11 | Gel | 7.0 | 350 | 1.9 | 217 | |
| P-12 | Gel | 7.0 | 77 | 0.52 | 268 | 900° C., |
| | | | | | | pyrolyzed P-11 |
| P-13 | ppt | 12.5 | 115 | 0.66 | 229 | |
| P-14 | ppt | 12.3 | 87 | 0.65 | 255 | |
| P-15 | ppt | 12.3 | 87 | 0.65 | 298 | 900° C., |
| | | | | | | pyrolyzed P-14 |
| P-16 | ppt | 11.3 | 41 | 0.17 | 167 | |

In Table 1, P-1, P-2, P-3, P-4, and P7 to P12 are silica gel particles, and P-5, P-6, P-13 to P16 are precipitated silica particles. P-2, P-4, P-6, P-8, P-10, P-12 and P-16 are silica samples that have gone through 10 hours of high temperature (900° C.) of pyrolysis. After the heat treatment, both BET and PV have been reduced.

Table 2 lists properties of some commercial hydrophobized silica particles used in the examples such as median particle size (PS) D50, BET surface area (BET), pore volume (PV), Pore diameter (PD) and C % content (for modified samples only).

TABLE 2

| | | PS | | | | |
|---|---|---|---|---|---|---|
| Particle | | D50 | BET | PV | PD | |
| Identification | Material | (μm) | (m²/g) | (cc/g) | (Å) | C % |
| P-17 | Precipitated | 11 | 40 | 0.4 | 400 | n/a |
| | Silica | | | | | |
| P-18 | Dumacil ® 300FG | 12 | 140 | 0.5 | 143 | 2.4 |
| | (PDMS modified | | | | | |
| | precipitated | | | | | |
| | silica) | | | | | |
| P-19 | Calcinated | 12 | 140 | 0.5 | 143 | 0 |
| | Dumacil ® 300FG | | | | | |
| P-20 | Zeoflo ® TL | 4.5 | 51 | 0.2 | 157 | 1.8 |
| | (PDMS modified | | | | | |
| | precipitated | | | | | |
| | silica) | | | | | |
| P-21 | Zeoflo ® MD | 8.5 | 60 | 6.2 | 133 | 1.3 |
| | (PDMS modified | | | | | |
| | precipitated | | | | | |
| | silica) | | | | | |

In Table 2, P-17 is unmodified precipitated silica particles commercially available from W.R. Grace & Co (Columbia, Md.). P-18 (commercially available from Elementis Specialties St. Louis, Mo.), P-20, P-21 are commercially available hydrophobic silica particles from Evonik (Essen, Germany). It is believed that P-18, P-20 and P-21 were prepared by reactions of silica particle with commercially available silicone oils or polydimethylsiloxanes (PDMS), for example, as described in U.S. Pat. No. 8,614,256. These particles were used directly without further chemical modification. P-19 was calcinated P-18 (Heated at 500° C. in air overnight) to burn off all the organics and leave only SiO₂ in the particles, and its further modifications were described in Examples below.

Table 3 lists hydrophobilizing agents used in Modification of Silica Particles.

TABLE 3

| | | Molecular |
|---|---|---|
| | | Weight |
| Identification | Chemical Name | (Dalton) |
| PDMS | CRTV944 (Silanol terminated | ~15000 |
| | polydimethylsiloxane) | |
| C18 Silane | Octadecyltrimethoxysilane | 375 |
| F13 Silane | Triethoxy(3,3,4,4,5,5,6,6,7,7,8,8- | 510 |
| | tridecafluoro-1-octyl)silane | |

In Table 3, CRTV944 was commercial silicone oil supplied by Momentive Performance Materials (Waterford, N.Y.), and C18 and F13 silanes were commercial silanes from Gelest Inc. (Morrisville, Pa.) or Sigma-Aldrich (St. Louis, Mo.).

### Modification Procedures for Hydrophobized Particles

### Solution Modification:

In a 100 ml Nalgene® bottle was charged with 2 g of oven dried, unmodified particles (from Table 1), 0.2 g of silane (C18 or F13 silane in Table 3) and 40 ml of anhydrous toluene. The cap of the bottle was closed tightly. The materials inside the bottle were then mixed on a mechanical rotator like a Roto-Torque model 7637 from Cole-Parmer. The mixing was continued for overnight (at least 10 hours). And then the product was used directly in coating formulations.

### Dry Modification:

Both a 500 mL round bottom flask and starting particles were oven dried, for example, at 120° C. for about 12 hours. In the flask is charged with the oven-dried starting particles. Then, a certain amount of PDMS was added into the flask using a pipette dropwise while the flask was frequently shaken so that the starting particles and the PDMS were mixed as homogeneously as possible. If the silicone oil was too viscous, a small amount of toluene was used to dissolve the PDMS, and then the dissolved PDMS was added. The mixture of the PDMS and the particles were allowed to roll on a rotavap at room temperature for at least about 5 hours to about 12 hours. Then, the mixture of the PDMS and the particles was transferred into a crystalline dish, which was then placed in a fume hood for a few hours to allow toluene, if used, to evaporate. Finally, the crystalline dish containing the mixture of the PDMS and the particles is placed in an oven and baked at 120° C. for about 12 hours.

### Milling and Modification:

A 10″ spiral jet mill with eight 0.011″ grind holes was used. The grinding chamber of the spiral jet mill was modified so that a 0.8 mm nozzle could be inserted from outside to inside of the grinding ring wall. This nozzle was connected to a metering pump which was used to meter in the PDMS.

Specifically, the bonding procedure includes the following steps. First, the mill superheater was brought up to a temperature, for example, in a range from 300 F to 340 F. An Acrison Loss-in-weight feeder was filled with the particles to be milled. The feeder was set to a constant rate of 40 lb/hr of particles. During the bonding, the temperature of the mill superheater was constantly being adjusted by a control system to keep the mill outlet temperature between 300-340 F, and the mill grinding pressure and injection pressure were controlled at 18 and 80 psi, respectively. Then, a pre-calibrated metering pump was turned on to inject PDMS through the nozzle into the milling chamber. As such, the particles and PDMS were being added to the mill at the same time. This process continued until a desired amount of milled-hydrophobic product is produced.

### Preparation of Coating Compostions

The hydrophobically modified/bonded particles are mixed separately with five different types of film forming binders in some solvents to create the coating formulations, and these binders and formulations are listed below:

### Binder System 1:

A fluorine containing polymers such as fluoro-elasomer (for example, DAI-EL® G802 from Daikin America, Inc. (Orangeburg, N.Y.)) can be used as film forming binder. G802 is a peroxide curable copolymer with about 66% fluorine content and specific gravity of 1.81. The 10 w/w % solution in acetone was prepared by heating and stirring the polymer in acetone for about 2 hours, and the solution was used as stock solution.

Some pre-determined amounts of bonded particles were mixed with the above solution. Toluene or acetone was added to make the mixture at the desired ratios and concentrations. The mixture was sonicated in a sonic batch for 1 hour. And then the mixture was used directly with either spin coating or other coating methods on substrates to create coated film on the substrates.

To improve the durability of the coated film, crosslinking was used in some cases. In these cases, about 4% of triallyl isocyanurate and 3% of dicumyl peroxide (percentage to the weight of the G802 polymer used) were dissolved in the coating formulation right before the coating was applied. Thermal treatment of 120° C. for 1 hour enabled the crosslinking reactions to happen among binder molecules in the coated film.

### Binder System 2:

A hydrophobic polyurethane can be used as film forming binder. For example, IROGRAN® A 85 P 4394 is a polyether-based, hydrophobic thermoplastic polyurethane (TPU) mainly used for extrusion and injection molding applications commercially. This product is manufactured by Huntsman Corporation (Woodlands, Tex.). The 2.9 w/w % stock solution in dimethylformamide (DMF) was prepared by dissolving the right amount of polymer in DMF with sonication in a sonic bath for 1 hour, and this solution was used as stock solution.

Some pre-determined amounts of bonded particles were added into the above solution to make the mixture at the desired ratios. The mixture was sonicated in a sonic batch for 1 hour. And then the mixture was used directly with either spin coating or other coating methods on substrates to create coated film on the substrates.

After coating, thermal treatment of 120° C. enables a layer of coated film with homogeneous distributed particles in the TPU.

### Binder System 3:

Wax emulsions can be used as film forming binders. For example, API-WP30C was obtained from Advanced Polymer, Inc. (Carlstadt, N.J.). It is an aqueous paraffin wax emulsion stabilized by anionic surfactants. AW-703 was obtained from A & W Products, Inc. (Bishop, Ga.), and it is an aqueous polyethylene wax co-emulsion stabilized by anionic surfactants. Both emulsions can be used to create coated films on porous substrates such as wood or concrete.

To create a good mixing for the wax emulsion particles and the hydrophobically modified particles in water, it was found that he hydrophobic particles needed to be dispersed in water first. Towards this end, 10 grams of the particle samples were mixed with about 0.42 grams (4.2 wt %) of Triton X-100 (Dow Chemical Company) in 190 g of water with high shear mixing (Silverson mixer at about 6000 rpm) for about 30 minutes. Then the dispersed particles in water could be mixed with wax emulsions, further diluted with water to make the formulation with desired concentrations prior to the coating steps.

### Binder System 4:

Polymer emulsions can also be used as film forming binder. For example, A polyolefin (PO) emulsion CANVERA™ 1110 was obtained from Dow Chemical Company (Midland, Mich.). It is an aqueous acid-modified polyolefin dispersion designed for beverage spray coatings.

To create a good mixing for the PO emulsion particles and the hydrophobically modified particles in water, the hydrophobic particles needed to be disperse in water first. Towards this end, 10 grams of the particle samples were mixed with about 0.42 grams (4.2 wt %) of Triton X-100 (Dow Chemical Company) in 190 grams of water with high shear mixing (Silverson mixer at about 6000 rpm) for about 30 minutes. Then the dispersed particles in water were mixed with wax emulsions to make the desired concentrations prior to the coating steps.

### Binder System 5:

The film forming binders can also be formed with polymerization or gelation in situ after coating, and this is especially true for rubbery type of materials. For example, silanol terminated PDMS, CRTV942 (Viscosity 4000 cP, available from Momentive Company (Waterford, N.Y.)), 5 wt % (to the weight of PDMS) of tetraethyl orthosilicate (TEOS), and 2.5 wt % (to the weight of PDMS) of Dibutyltin dilaurate (DBTDL) were mixed in toluene, and some desired amounts of hydrophobic particles were then added. The mixture was let to sit for 10 hours, and then was sonicated in a sonic batch for 30 minutes, and this was followed by a coating procedure to form a coated silicone rubber film.

### Coating Methods

### Spin Coat

Spin coating can be applied onto flat substrates such as non-porous substrates such as glass slides, aluminum, or high-density polyethylene (HDPE), or porous substrates such as wood or concrete. Typically, in experiments to demonstrate the effect, substrates were cut in 3 inch×3 inch in size to allow them to fit in the coater. A Ni-Lo 4 Spin Coater from Ni-LO Scientific (Ottawa, Canada) with a built-in vacuum holder was used for the coating. Prior to coating, the substrates were cleaned with solvents or water and were then blown dry. For woods, sand paper might be used to make surface flat.

Coating procedure: the substrate sample was placed onto coating with vacuum. Approximately 5-8 ml of the formulations from previous section were transferred onto substrate with a pipette. Caution was taken to ensure that all the surface was covered with formulation. Then the coating was carried out at 500 or 1000 rpm for 1 minutes. After this step, the solvents were allowed to evaporate and then the coated substrates were placed in an oven at a temperature of 120° C. for 1 hour.

### Drawdowns

Drawdowns can be applied to larger area of surfaces. They were carried out with a wire wound lab rod from Gardner Company with wire size of 40. With this size, the wet film thickness was about 100 μm. The procedure for each drawdown was as follows.
a. In a dust free clean room, a flat substrate was placed on a vacuum holder.
b. Using a pipette, about 5-10 ml of a well-mixed coating composition sample was positioned on and near the top of a sample sheet.
c. The ends of the drawdown rod were immediately grasped. Using the thumbs of both hands to keep the rod from bowing or bending away from the sample, the drawdown rod was drawn down through the liquid pool, spreading and metering the fluid across the sample sheet. After a given drawdown was made, the drawdown rod was immersed in a cleaning tray after use.
d. After the drawdown, the drawdown samples were left at room temperature for solvent evaporation, and then the coated substrates were placed in an oven at a temperature of 120° C. for 1 hour.

Dip Coating

For flexible substrate such as fabrics (e.g., cloth) or paper, the whole piece of materials were immersed in the formulation. Then the substrates were taken out and solvents were allowed to evaporate. Then the samples were placed in an oven at a temperature of 120° C. for 1 hour.

### Spray Coating

The coating could also be applied onto substrates using a paint sprayer. A 2-piece HVLP Gravity Feed Air Spray Gut Kit with 0.8 mm nozzle from PowRyte (La Puente, Calif.) was used. The coating formulations were placed in the sample bottle and then the spray was applied under 30 psi air flow to various surfaces.

### Evaluation of Coated Films on Substrates

### Rolling Ratings of the Coated Films

After coating and sometimes heat treatment for the coated layer, and superhydrophobicity of the surfaces were evaluated with droplets of deionized water with a rolling rating range of 0, 1, 2 and 3:
0—water droplet sticks to the substrate
1—water droplet only slides in some parts when inclined at 60°
2—water droplet slides when inclined at 30°
3—water droplet slides completely in all parts when inclined at 5°

### Static Water Contact Angles of the Coated Films:

A “pinning” method was used to place the drops on the surface. A drop of the probe liquid (distilled water) was placed on the surface from a distance of 2.5 mm from a 22-gauge blunt-tipped needle. The drop was held in contact with the sample surface for 4 seconds. The liquid was then slowly withdrawn from the surface until a free-standing drop was formed. The drop was then photographed immediately with a 36× digital camera. Typical drop volume was 3 μL. At least six different drops were photographed for each surface and each liquid. The drop photos were then processed using ImageJ, a digital image processing software, and a contact angle measuring plugin. The angles were measured using best elliptical fitting results. The following Table 4 shows the results of water droplet contact angle measurement vs. rating it was given using the criteria mentioned above.

TABLE 4

| Rolling Rating | Static Contact Angles Measured |
|---|---|
| 0 | 117 ± 0.5° |
| 1 | 142 ± 2.5° |
| 2 | 144 ± 1.4° |
| 3 | 150 ± 2.5° |

### EXAMPLES

### Examples 1-17

Table 5 lists Examples 1-17 that mainly demonstrate influence of pore diameter to the superhydrophobic performance ratings when modified particles were used in formulations and the formulated formulations were coated on glass slides. In these examples, the bonding molecule was C-18 silane and the binder system used was fluoro-elastomer system (formulation 1 described above). 5% of modified particles and 5% of binder was used in these examples. The table illustrates the choices of particles (particle size and pore diameter), their modification levels (the amount of C18 silane used), and superhydrophobicity rating of the coated films.

TABLE 5

| | | | | hydrophobizing | Treatment | |
|---|---|---|---|---|---|---|
| Example | Particle | PS | PD | agents (wt % | Level | Film |
| # | Choice | (μm) | (Å) | amount) | (μmol/m²) | rating |
| 1 | P-1 | 5 | 23 | C18 (86.6%) | 3.3 | 0 |
| 2 | P-1 | 5 | 23 | C18 (46.6%) | 1.8 | 0 |
| 3 | P-2 | 5 | 32 | C18 (14.5%) | 1.8 | 0 |
| 4 | P-4 | 5 | 67 | C18 (5.8%) | 1.8 | 0 |
| 5 | P-3 | 5 | 80 | C18 (33.5%) | 1.8 | 1 |
| 6 | P-5 | 6 | 107 | C18 (49.9%) | 1.8 | 3 |
| 7 | P-6 | 6 | 111 | C18 (20.0%) | 1.8 | 3 |
| 8 | P-7 | 9 | 137 | C18 (43.3%) | 3.3 | 3 |
| 9 | P-8 | 9 | 164 | C18 (14.7%) | 1.8 | 3 |
| 10 | P-9 | 8 | 188 | C18 (22.8%) | 1.8 | 3 |
| 11 | P-10 | 8 | 183 | C18 (15.2%) | 1.8 | 3 |
| 12 | P-11 | 7 | 217 | C18 (43.3%) | 3.3 | 3 |
| 13 | P-12 | 7 | 268 | C18 (5.2%) | 1.8 | 3 |
| 14 | P-13 | 12.5 | 229 | C18 (14.0%) | 3.3 | 3 |
| 15 | P-14 | 12.1 | 255 | C18 (17.9%) | 3.3 | 3 |
| 16 | P-15 | 12.3 | 298 | C18 (10.6%) | 3.3 | 3 |
| 17 | P-16 | 11.3 | 167 | C18 (5.0%) | 3.3 | 3 |

In Examples 1-4, silica samples with low PDs (PD<80 Å) were treated with C18 silane at different treatment levels, and the modified particles were formulated with hydrophobic binder with cross-linking. After the formulation was spin coated on glass slides and cured, the superhydrophobic ratings for these samples were 0.

In Example 5, silica sample (P-3) with PD of around 80 Å was modified with C18 silane, the modified particles were formulated with hydrophobic binder with cross-linking. After the formulation was spin coated on glass slides and cured, the superhydrophobicity rating was 1.

In Examples 6-17, silica samples with PD of over 100 Å were treated with C18 silane at different treatment levels, and the modified particles were formulated with hydrophobic binder with cross-linking. After the formulation was spin coated on glass slides and cured, the superhydrophobicity ratings for these samples were unexpectedly all 3.

### Examples 18-30

Table 6 lists examples 18-30 with regard to the choices of particles, their modifications, hydrophobicity of the particles, binders and formulations used, coating methods used, and superhydrophobicity rating of the coated films.

TABLE 6

| | Particles | | | | | |
|---|---|---|---|---|---|---|
| | (size if not | Modification | | | | |
| Example | mentioned | Types and | Binder | Ratios and | Costing | |
| Number | elsewhere | Methods | System | Concentrations | Methods | Rating |
| 18 | P-17 | 10% PDMS | 1 | 5% Particles, | Spin | Glass: 2 |
| | (12 μm) | (Dry bonding) | | 5% Binder | Coating | Wood: 3 |
| 19 | P-17 | 10% PDMS | 3 | 5% Particles | Spin | Glass: 3 |
| | (8 μm) | (Milling and | | (Triton X100), | Coating | |
| | | bonding) | | 5% Binder | | |
| 20 | P-17 | 10% PDMS | 3 | 4% Particles | Spin | Glass: 3, |
| | (8 μm) | (Milling and | | (Triton X100), | Coating | Cardboard: 3 |
| | | bonding) | | 5% Binder | | |
| 21 | P-18 | Commercial | 4 | 2% Paticles, | Spin | Wood: 2 |
| | | Hydrophobic | | 2% Binder | Coating | |
| | | Silica | | | | |
| 22 | P-17 | 10% PDMS | 1 | 4% Particles | Spin | Glass 3, |
| | (8 μm) | (Milling and | | (TWEEN 20), | Coating | Cardboard: 3 |
| | | bonding | | 5% Binder | | |
| 23 | P-18 | Commercial | 1 | 2% Particles, | Spin | Glass: 3 |
| | | Hydrophobic | | 1% Binder | Coating, | Wood: 3 |
| | | Silica | | | drawdown | |
| | | | | | (glass), | |
| | | | | | Soak | |
| | | | | | (paper | |
| | | | | | and cloth) | |
| 24 | P-18 | Commercial | 2 | 1.90% Particles, | Spin | 2 for one coat, |
| | | Hydrophobic | | 2.86% Binder | Coating | 3 for 2 coats |
| | | Silica | | | | (wood substrate) |
| 25 | P-20 | Commercial | 1 | 5% Particles, | Spin | Glass: 3 |
| | | Hydrophobic | | 5% Binder | Coating | |
| | | Silica | | | | |
| 26 | P-21 | Commerical | 1 | 5% Particles, | Spin | Glass: 3 |
| | | Hydrophobic | | 5% Binder | Coating | |
| | | Silica | | | | |
| 27 | P-19 | Calcinated, | 1 | 2% Particles, | Spin | Glass: 0 |
| | | no further | | 4% Binder | Coating | |
| | | modification | | | | |
| 28 | P-19 | 10% PDMS | 1 | 2% Particles, | Spin | Glass: 3 |
| | | (Dry bonding) | | 4% Binder | Coating | Wood: 3 |
| 29 | P-19 | 10% C18 | 1 | 2% Particles, | Spin | Glass: 3 |
| | | (Solution | | 4% Binder | Coating | Wood: 3 |
| | | bonding | | | | |
| 30 | P-19 | 10% F13 | 1 | 2% Particles, | Spin | Glass: 3 |
| | | (Solution | | 4% Binder | Coating | Wood: 3 |
| | | bonding | | | | |

As shown in the table, except for Example 27, all other particles, when used in the formulations and coated on surfaces, gave superhydrophobicity rating of 2 or 3. In Example 27, because of the particles were unmodified (after calcination, all surface organics were removed), the superhydrophobicity rating was 0 for the coated film.

### Example 18

In example 18, 12 μm median sized particles (P-17 in Table 2) were bonded with 10 wt % of PDMS (Table 3) using the dry bonding procedure as described above. Then 5 wt % of the particles were mixed with 5 wt % of G-802 binder in acetone. The spin coated layer of this formulation had a rating of 2 on glass slides and 3 on wood substrates.

### Example 19

In example 19, 12 μm median sized particles (P-17) were bonded with 10 wt % of PDMS using the milling and bonding procedure as described above. The median particle size after the bonding process was reduced to about 8 μm. Then 5 wt % of the particles (first dispersed in water using about 4.6 wt % of Triton X100 surfactant. Here, the percent amount of surfactants was relative to the amount of silica. Same description below) were mixed with WP-30C wax emulsions to make the final silica and wax amounts at 5 wt % and 5 wt %, respectively. The spin coated layer of this formulation had a rating of 3 on wood substrates.

### Example 20

In example 20, modified particles as described in Example 19 were used. 5 wt % of the particles (first dispersed in water using about 10 wt % of Triton X100 surfactant) were mixed with WP-30C wax emulsions to make the final amounts of silica and wax at 4 wt % and 5 wt %, respectively. The spin coated layer of this formulation had a rating of 3 on wood substrates.

### Example 21

In example 21, commercially available hydrophobic particles P-18 (Table 2) were used, and the particles were dispersed in water under high shear with 10 wt % of Triton X-100, and then were mixed with CANVERA™ 1110 (PO aqueous emulsion binder) with a final concentration of 2 wt % of particles, and 2 wt % of binders as described before. The spin coated layer of this formulation had a rating of 0 on glass, but 2 on wood.

### Example 22

In example 22, once again the modified particles as described in Example were used. 5% of the particles (first dispersed in water using about 10 wt % of TWEEN® 20 surfactant) were mixed with WP-30C wax emulsions to make the final silica and wax amounts at 4 wt % and 5 wt %, respectively. The spin coated layer of this formulation had ratings of 3 on wood and cardboard substrates.

### Example 23

In example 23, commercially available hydrophobic particles P-18 were used. And 2 wt % of these particles were mixed with 1 wt % of G-802 binder with 0.2 wt % of triallyl isocyanurate and 0.15 wt % of dicumyl peroxide as described before in acetone. The spin coated layer of this formulation had a rating of 3 on glass, wood, metal and HDPE substrates. Drawdowns were also carried out with these substrates with similar superhydrophobicity rating. In another set of experiments, the same formulation was used to soak coating cloth and paper, with superhydrphobicity rating of 3 as well.

### Example 24

In example 24, commercially available hydrophobic particles P-18 were used. And 2% of the particles were mixed with 1% of G-802 binder with 0.2% of triallyl isocyanurate and 0.15% of dicumyl peroxide as described before in acetone. The spin coated layer of this formulation had a rating of 3 on glass.

### Example 25

In example 25, commercially available hydrophobic particles P-20 (Table 2) were used, and 1.9 wt % of these particles were mixed with 2.86 wt % of IROGRAN® A 85 P 4394 (TPU binder) in DMF (particle to binder ratio of 66.6%). The spin coated layer of this formulation had a rating of 2 on wood with one coat, and 3 with two coats (120° C. thermal treatment for 1 hour after each coat).

### Example 26

In example 26, commercially available hydrophobic particles P-21 (Table 2) were used. And 5% of the particles were mixed with 5 wt % of G-802 binder with 0.2 wt % of triallyl isocyanurate and 0.15% of dicumyl peroxide as described before in acetone. The spin coated layer of this formulation had a rating of 3 on glass.

### Example 27

in example 27, Particles P-19 (calcinated P-18 particles, Table 2) were used, and as mentioned before, the calcinated particles (after calcination, no organic groups were left on particles and the particles became hydrophilic) at 5 wt % were mixed with 5% of G-802 binder with 0.2 wt % of triallyl isocyanurate and 0.15 wt % of dicumyl peroxide as described before in acetone. The spin coated layer of this formulation had a rating of 0 on glass. This example proves that hydrophobic modification of the particles is needed for the coated film containing the hydrophobic particles to exhibit superhydrophobicity property.

### Example 28

In Example 28, Particles P-19 were bonded with 10 wt % of CRTV944 with dry bonding procedure. After the modification, the particle became hydrophobic again. Then modified particles were then mixed with G-802 binder in acetone. The final concentration of the formulation contained 2 wt % of particles and 4 wt % of binders. The mixture was coated onto glass and wood substrate with ratings of 3.

### Example 29

In Example 29, Particles P-19 were bonded with 10 wt % of C18 silane with solution bonding procedure. After the modification, the particle became hydrophobic again. Then modified particles were then mixed with G-802 binder in acetone. The final concentration of the formulation contained 2 wt % of particles and 4 wt % of binders. The mixture was coated onto glass and wood substrate with ratings of 3.

### Example 30

In Example 30, Particles P-19 were bonded with 10 wt % of F13 silane with solution bonding procedure. After the modification, the particle became hydrophobic again. Then modified particles were then mixed with G-802 binder in acetone. The final concentration of the formulation contained 2 wt % of particles and 4 wt % of binders. The mixture was coated onto glass and wood substrate with ratings of 3.

1. A coating composition, comprising:
hydrophobized silica particles;
a film-forming binder; and
a solvent;
wherein the hydrophobized silica particles comprise porous silica particles having a pore diameter of about 80 Å or more which have been treated to form a hydrophobic coating on a surface of the porous silica particles.

2. The coating composition of claim 1, wherein a weight ratio of the hydrophobized silica particles to the film-forming binder in the coating composition is at least about 1:2.5.

3. The coating composition of claim 1, wherein the solvent comprises one or more organic solvents or water.

4. The coating composition of claim 1, wherein a BET surface of the porous silica particles is less than about 800 m²/g.

5. The coating composition of claim 4, wherein the BET surface of the porous silica particles is less than about 750 m²/g.

6-7. (canceled)

8. The coating composition of claim 1, wherein the hydrophobic coating on the surface of the porous silica particles is formed by contacting the porous silica particles with a hydrophobic silane or siloxane that contains at least one reactive functional group that undergoes a chemical reaction with surface silanol groups of the porous silica particles.

9. The coating composition of claim 8, wherein the hydrophobic silane or siloxane preferably has a weight averaged molecular weight of at least 200 daltons.

10. (canceled)

11. The coating composition of claim 8, wherein the hydrophobic silane or siloxane is octadecyl trimethoxysilane, perfluorooctyltrimethoxysilane, polydimethoxysilane, or silanol terminated polydimethylsiloxane, more preferred is polydimethoxysilane.

12-15. (canceled)

16. The coating composition of claim 11, wherein the hydrophobic silane is polydimethoxysilane.

17. The coating composition of claim 1, wherein the film-forming binder comprises one or more selected from the group consisting of C₂-C₆ polyolefins; homopolymers of ethylenically unsaturated monomers containing C₈-C₃₆ alkyl groups; and copolymers of ethylenically unsaturated monomers containing C₄-C₃₆ alkyl groups, C₁ to C₃₆ alkyl vinyl ethers, vinyl esters of C₁ to C₃₆ carboxylic acids, and ethylenically unsaturated comonomers copolymerizable therewith; natural waxes; and synthetic waxes.

18. The coating composition of claim 1, wherein the film-forming binder comprises a fluorine-containing polymer and the solvent comprises one or more organic solvents.

19. The coating composition of claim 18, wherein the fluorine-containing polymer is polytetrafluoroethylene, polyhexafluoropropene, tetrafluoroethylene hexafluoropropene copolymer, alkoxy fluoroethylene copolymer, ethylene-tetra fluoroethylene copolymer, or a combination thereof.

20. The coating composition of claim 18, further comprising a cross-linker for crosslinking the film-forming binder.

21. (canceled)

22. The coating composition of claim 18, wherein the film-forming binder further comprises a gelation agent.

23. The coating composition of claim 1, wherein the film-forming binder comprises an aqueous wax emulsion or an aqueous emulsion of a hydrophobic polymer and the solvent comprises water.

24. The coating composition of claim 23, wherein the coating composition is prepared by dispersing the hydrophobized silica particles in water in a presence of a surfactant to form a suspension of the hydrophobized silica particles, and then mixing the wax emulsion or the emulsion of the hydrophobic polymer with the suspension of the hydrophobized silica particles.

25. The coating composition of claim 1, wherein the film-forming binder is present in an amount of about 1% to about 30% by weight of the coating composition.

26. The coating composition of claim 1, wherein the coating composition is in a form of aerosol further comprising at least one propellant.

27. A hydrophobic film formed from the coating composition of claim 1, wherein the hydrophobic film exhibits a static contact angle for deionized water at room temperature equal to or greater than about 140° and a rolling rating of at least 1 in a scale of 0-3.

28. The hydrophobic film of claim 27, wherein the hydrophobic film is produced by a method selected from the group consisting of spin coating, dip coating, spray coating, roller coating, drawdown, brush coating, and a mixture thereof.

29. An article, comprising at least one difficult-to-wet surface which is composed essentially of a coating composition, the coating composition comprising:
hydrophobized silica particles;
a film-forming binder; and
a solvent,
wherein the hydrophobized silica particles comprise porous silica particles having a pore diameter of about 80 Å or more which have been treated to form a hydrophobic coating on a surface of the porous silica particles.

30. The article of claim 29, wherein the difficult-to-wet surface exhibits a static contact angle for deionized water at room temperature equal to or greater than about 140° and a rolling rating of at least 1 in a scale of 0-3.

31. The article of claim 30, wherein the article preferably comprises a material selected from the group consisting of glass, metal, plastics, wood, concrete, fabrics, cellulosic materials, and paper.
